(19) United States
(12) Patent Application Publication
(10) Pub. No.: US 2025/0309302 A1
(43) Pub. Date: Oct. 2, 2025

(54) GAS-LIQUID SEPARATOR AND FUEL CELL SYSTEM

(71) Applicants: HYUNDAI MOTOR COMPANY, Seoul (KR); KIA CORPORATION, Seoul (KR)

(72) Inventors: Joon Kyoung Kang, Seoul (KR); Min Woo Kim, Seoul (KR); Min Su Hyeon, Suwon-si (KR)

(73) Assignees: HYUNDAI MOTOR COMPANY, Seoul (KR); KIA CORPORATION, Seoul (KR)

(21) Appl. No.: 18/797,834

(22) Filed: Aug. 8, 2024

(30) Foreign Application Priority Data
Mar. 26, 2024 (KR) 10-2024-0041283

(51) Int. Cl. H01M 8/0662; B01D 45/02; B01D 45/08; H01M 8/2475; H01M 8/2484

(52) U.S. Cl. CPC H01M 8/0662; B01D 45/02; B01D 45/08; H01M 8/2475; H01M 8/2484

(57) ABSTRACT

The present disclosure relates to a gas-liquid separator including a first pipe member, a second pipe member configured to communicate with the first pipe member and connected to an upper end of the first pipe member based on a gravitational direction, and a gas-liquid separation member provided in the first pipe member and the second pipe member so that droplets contained in air, which moves upward along the first pipe member and the second pipe member, come into contact with the gas-liquid separation member, thereby advantageously and effectively capturing droplets from air discharged from a fuel cell stack.

### CROSS-REFERENCE TO RELATED APPLICATION

This application claims priority to and the benefit of Korean Patent Application No. 10-2024-0041283 filed in the Korean Intellectual Property Office on Mar. 26, 2024, the entire contents of which are incorporated herein by reference.

### TECHNICAL FIELD

The present disclosure relates to a gas-liquid separator and a fuel cell system, and more particularly, to a gas-liquid separator and a fuel cell system, which are capable of effectively capturing droplets from air discharged from a fuel cell stack.

### BACKGROUND

A fuel cell vehicle (e.g., a hydrogen fuel cell vehicle) is configured to autonomously generate electricity by means of a chemical reaction between fuel (hydrogen) and air (oxygen) and travel by operating a motor.

In general, the fuel cell vehicle may include a fuel cell stack configured to generate electricity by means of an oxidation-reduction reaction between hydrogen and oxygen, a fuel supply device configured to supply fuel (hydrogen) to the fuel cell stack, an air supply device configured to supply the fuel cell stack with air (oxygen), which is an oxidant required for an electrochemical reaction, and a thermal management system (TMS) configured to discharge heat, which is generated from the fuel cell stack and power electronic parts of the vehicle, to the outside of the system and control temperatures of the fuel cell stack and the power electronic parts.

Further, discharge water (condensate water) and exhaust gas (e.g., air), which are produced during the operation of the fuel cell stack, may be discharged to the outside through an exhaust pipe.

Droplets may be contained in the air discharged during the operation of the fuel cell stack. When the air containing droplets is discharged to surrounding pedestrians or peripheral devices, the air containing droplets may cause unpleasantness to the surrounding pedestrians or corrosion of the peripheral devices.

In addition, when the air containing droplets is discharged onto a floor (e.g., on a road or a floor of an indoor workplace), the floor may be contaminated, and the risk of the occurrence of various types of accidents (e.g., slip and fall accidents, electric shock accidents, etc.) caused by droplets on the floor may be increased. Therefore, it is necessary to remove droplets, which are contained in the air discharged during the operation of the fuel cell stack, as much as possible.

Therefore, recently, various types of studies have been conducted to effectively remove the droplets from the air discharged during the operation of the fuel cell stack, but the study result is still insufficient. Accordingly, there is a need to develop a technology to effectively remove the droplets from the air discharged during the operation of the fuel cell stack.

### SUMMARY

The present disclosure has been made in an effort to provide a gas-liquid separator and a fuel cell system, which are capable of effectively capturing droplets contained in air discharged from a fuel cell stack.

The present disclosure has also been made in an effort to ensure performance in capturing droplets contained in air discharged from a fuel cell stack and simplify a discharge route for air.

The present disclosure has also been made in an effort to simplify a structure, contribute to miniaturizing a fuel cell system, and improve a degree of design freedom and spatial utilization.

The objects to be achieved by the embodiments are not limited to the above-mentioned objects, but also include objects or effects that may be understood from the solutions or embodiments described below.

In order to achieve the above-mentioned objects, an example embodiment of the present disclosure provides a gas-liquid separator including: a first pipe member; a second pipe member configured to communicate with the first pipe member and connected to an upper end of the first pipe member based on a gravitational direction; and a gas-liquid separation member provided in the first pipe member and the second pipe member so that droplets contained in air, which moves upward along the first pipe member and the second pipe member, come into contact with the gas-liquid separation member.

The gas-liquid separator may effectively capture droplets contained in air discharged from a fuel cell stack.

In other words, droplets may be contained in the air discharged during the operation of the fuel cell stack. When the air containing droplets is discharged to surrounding pedestrians or peripheral devices, the air containing droplets may cause unpleasantness to the surrounding pedestrians or corrosion of the peripheral devices. In addition, when the air containing droplets is discharged onto a floor (e.g., on a road or a floor of an indoor workplace), the floor may be contaminated, and the risk of the occurrence of various types of accidents (e.g., slip and fall accidents, electric shock accidents, etc.) caused by droplets on the floor may be increased. Therefore, it is necessary to remove droplets, which are contained in the air discharged during the operation of the fuel cell stack, as much as possible.

In contrast, according to an embodiment of the present disclosure, the air, which is discharged along the first pipe member and the second pipe member, passes through the gas-liquid separation member, such that the amount of droplets contained in the air to be discharged to the outside may be minimized. Therefore, it is possible to advantageously reduce the risk of the occurrence of contamination and accidents caused by the discharge of the droplets.

Among other things, according to an embodiment of the present disclosure, the droplets contained in the air discharged from the fuel cell stack are stored in a storage part (e.g., a water trap) without being discharged directly to the outside, and the droplets are discharged only at a predetermined particular position. Therefore, it is possible to advantageously inhibit contamination caused by the droplets and reduce risks of the occurrence of accidents (e.g., a slip-and-fall accident, an electric shock accident, etc.).

Moreover, according to an embodiment of the present disclosure, the air, which is discharged along the first pipe member and the second pipe member, passes through the gas-liquid separation member, such that it is possible to effectively capture the droplets contained in the air discharged from the fuel cell stack without using the water trap and to effectively discharge the air. Therefore, it is possible to advantageously simplify the discharge route for air, contribute to miniaturizing the fuel cell system, and improve the degree of design freedom and spatial utilization.

The gas-liquid separation member may have various structures capable of capturing the droplets contained in the air. For example, a mesh member having a plurality of mesh holes may be used as the gas-liquid separation member.

According to an embodiment of the present disclosure, the gas-liquid separation member may be provided to be spaced apart from an inner surface of the first pipe member and an inner surface of the second pipe member. A falling flow path may be defined between the first pipe member, the second pipe member, and the gas-liquid separation member. The droplets, which are separated from the air by the gas-liquid separation member, may fall through the falling flow path.

As described above, in an embodiment of the present disclosure, the gas-liquid separation member is provided to be spaced apart from the inner surface of the first pipe member and the inner surface of the second pipe member. The falling flow path is defined between the first pipe member, the second pipe member, and the gas-liquid separation member, such that the droplets contained in the air may be captured by coming into contact with the gas-liquid separation member while moving along the first pipe member and the second pipe member. The air, from which the droplets are separated, may move upward (toward the outlet of the second pipe member) along an internal space of the gas-liquid separation member.

Further, the droplets, which are captured by the inner surface of the first pipe member, the inner surface of the second pipe member, and the gas-liquid separation member, are agglomerated, such that the weights of the droplets may increase. When the sizes (weights) of the droplets increase, the gravitational force applied by the weight becomes higher than the drag force, such that the droplets may more easily fall in a downward direction (a direction opposite to a direction toward the outlet) along the falling flow path.

According to an embodiment of the present disclosure, the first pipe member may be provided to have a first diameter, and the second pipe member may be provided to have a second diameter larger than the first diameter.

In an embodiment of the present disclosure described above, the second pipe member, which is provided at a downstream side of the first pipe member, has a larger diameter than the first pipe member, such that a flow velocity (pressure drop) of the air passing through the second pipe member may be reduced on the basis of Bernoulli's principle. Therefore, it is possible to advantageously further reduce the likelihood of the discharge of the droplets (the upward movement of the droplets) in the second pipe member.

According to an embodiment of the present disclosure, the fuel cell system may include an exhaust duct connected to an upper end of the second pipe member and configured to discharge the air to the outside.

The exhaust duct may have various structures capable of discharging the air, which moves along the second pipe member, to the outside.

According to an embodiment of the present disclosure, the exhaust duct may include: a duct housing connected to the upper end of the second pipe member and having a larger volume than the second pipe member; and a discharge port provided in the duct housing and configured to discharge the air to the outside of the duct housing.

According to an embodiment of the present disclosure described above, the duct housing has a larger volume than the second pipe member, such that the flow velocity of the air discharged through the second pipe member may be reduced on the basis of Bernoulli's principle. Therefore, it is possible to advantageously and more effectively capture the droplets contained in the air on an inner surface of the duct housing.

According to an embodiment of the present disclosure, the second pipe member may be connected to one end of the duct housing. The discharge port may be provided at the other end of the duct housing and spaced apart from an outlet of the second pipe member. A horizontal movement flow path, through which the air moves in a horizontal direction, may be defined between the outlet of the second pipe member and the discharge port.

According to an embodiment of the present disclosure described above, the second pipe member is connected to one end of the duct housing, and the discharge port is provided at the other end of the second pipe member, such that a movement route for the air passing through the duct housing may be further extended (a contact area with the droplets may be increased). Therefore, it is possible to advantageously improve the efficiency in capturing the droplets by means of the duct housing.

According to an embodiment of the present disclosure, the discharge port may be configured to discharge the air to the outside in the gravitational direction.

According to an embodiment of the present disclosure described above, the discharge port discharges the air in the gravitational direction, such that the air, which moves along the horizontal movement flow path in the duct housing, may collide (come into contact) with the inner surface of the duct housing once more and then be discharged through the discharge port. Therefore, it is possible to advantageously further improve the efficiency in capturing the droplets by means of the duct housing.

According to an embodiment of the present disclosure, the fuel cell system may include a droplet capturing member provided on an inner surface of the duct housing and configured to capture droplets contained in the air discharged from the second pipe member.

According to an embodiment of the present disclosure described above, the droplet capturing member is provided on the inner surface of the duct housing, such that the contact area with the droplets may further increase. Therefore, it is possible to advantageously further improve the efficiency in capturing the droplets.

According to an embodiment of the present disclosure, the fuel cell system may include an inclined guide part provided on a bottom portion of the duct housing and configured to guide droplets, which are captured in the duct housing, to the second pipe member.

According to an embodiment of the present disclosure described above, the inclined guide part is provided on the bottom portion of the duct housing, such that the droplets captured in the duct housing may naturally flow downward along the inclined guide part and then be introduced into the second pipe member without stagnating in the duct housing.

Moreover, the droplets, which are introduced into the second pipe member along the inclined guide part, may be agglomerated with other droplets in the second pipe member (or the first pipe member) and form droplets having large sizes. Therefore, it is possible to advantageously further improve the efficiency in capturing and discharging the droplets.

Another embodiment of the present disclosure provides a fuel cell system including: a first fuel cell stack; a second fuel cell stack stacked on the first fuel cell stack; a first pipe member connected to the first fuel cell stack and configured to guide air discharged from the first fuel cell stack; a second pipe member connected to the second fuel cell stack and configured to communicate with the first pipe member, the second pipe member being connected to an upper end of the first pipe member based on a gravitational direction and configured to guide air discharged from the second fuel cell stack; and a gas-liquid separation member provided in the first pipe member and the second pipe member so that droplets contained in air, which moves upward along the first pipe member and the second pipe member, come into contact with the gas-liquid separation member.

According to an embodiment of the present disclosure, the gas-liquid separation member may be provided to be spaced apart from an inner surface of the first pipe member and an inner surface of the second pipe member. A falling flow path may be defined between the first pipe member, the second pipe member, and the gas-liquid separation member. The droplets, which are separated from the air by the gas-liquid separation member, may fall through the falling flow path.

According to an embodiment of the present disclosure, the first pipe member may be provided to have a first diameter, and the second pipe member may be provided to have a second diameter larger than the first diameter.

According to an embodiment of the present disclosure, the fuel cell system may include an exhaust duct connected to an upper end of the second pipe member and configured to discharge the air to the outside.

According to an embodiment of the present disclosure, the exhaust duct may include: a duct housing connected to the upper end of the second pipe member and having a larger volume than the second pipe member; and a discharge port provided in the duct housing and configured to discharge the air to the outside.

According to an embodiment of the present disclosure, the second pipe member may be connected to one end of the duct housing. The discharge port may be provided at the other end of the duct housing and spaced apart from an outlet of the second pipe member. A horizontal movement flow path, through which the air moves in a horizontal direction, may be defined between the outlet of the second pipe member and the discharge port.

According to an embodiment of the present disclosure, the fuel cell system may include a droplet capturing member provided on an inner surface of the duct housing and configured to capture droplets contained in the air discharged from the second pipe member.

According to an embodiment of the present disclosure, the fuel cell system may include an inclined guide part provided on a bottom portion of the duct housing and configured to guide droplets, which are captured in the duct housing, to the second pipe member.

According to an embodiment of the present disclosure, the fuel cell system may include a casing provided to surround a periphery of the first fuel cell stack and a periphery of the second fuel cell stack.

According to an embodiment of the present disclosure, the first pipe member, the second pipe member, and the exhaust duct may be provided in the casing.

### BRIEF DESCRIPTION OF THE DRAWINGS

FIG. 1 is a view of a fuel cell system according to an embodiment of the present disclosure.

FIG. 2 is a view of a gas-liquid separator of the fuel cell system according to an embodiment of the present disclosure.

FIG. 3 is a view of a pipe member and a gas-liquid separation member of the gas-liquid separator according to an embodiment of the present disclosure.

FIG. 4 is a view of flows of air and droplets in the gas-liquid separator according to an embodiment of the present disclosure.

### DETAILED DESCRIPTION

Hereinafter, embodiments of the present disclosure will be described in detail with reference to the accompanying drawings.

However, the technical spirit of the present disclosure is not limited to the embodiments described herein but may be implemented in various different forms. One or more of the constituent elements in the embodiments may be selectively combined and substituted for use within the scope of the technical spirit of the present disclosure. In addition, unless otherwise specifically and explicitly defined and stated, the terms (including technical and scientific terms) used in the embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

In addition, the terms used in the embodiments of the present disclosure are for explaining the embodiments, not for limiting the present disclosure.

In the present specification, unless particularly stated otherwise, a singular form may also include a plural form. The expression “at least one (or one or more) of A, B, and C” may include one or more of all combinations that can be made by combining A, B, and C.

In addition, the terms such as first, second, A, B, (a), and (b) may be used to describe constituent elements of the embodiments of the present disclosure.

These terms are used only for the purpose of discriminating one constituent element from another constituent element, and the nature, the sequences, or the orders of the constituent elements are not limited by the terms.

Further, when one constituent element is described as being ‘connected’, ‘coupled’, or ‘attached’ to another constituent element, one constituent element may be connected, coupled, or attached directly to another constituent element or connected, coupled, or attached to another constituent element through still another constituent element interposed therebetween.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

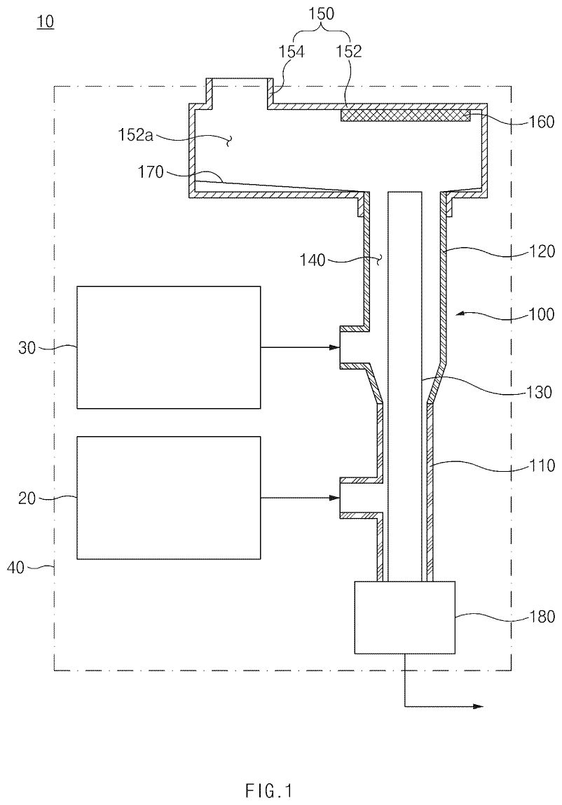

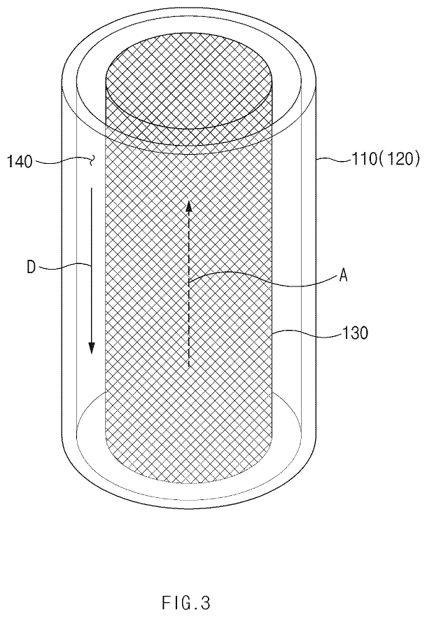

With reference to FIGS. 1-4, a gas-liquid separator 100 according to an embodiment of the present disclosure includes a first pipe member 110, a second pipe member 120 configured to communicate with the first pipe member 110 and connected to an upper end of the first pipe member 110 based on a gravitational direction, and a gas-liquid separation member 130 provided in the first pipe member 110 and the second pipe member 120 so that droplets contained in air, which moves upward along the first pipe member 110 and the second pipe member 120, may come into contact with the gas-liquid separation member 130.

For reference, the gas-liquid separator 100 according to an embodiment of the present disclosure may be used to capture the droplets from the air discharged from a fuel cell stack. The present disclosure is not restricted or limited by the type and properties of the object to which the fuel cell stack is applied.

Hereinafter, an example is described in which the gas-liquid separator 100 according to an embodiment of the present disclosure is applied to a fuel cell system 10 applied to mobility vehicles such as automobiles, ships, and airplanes.

According to an embodiment of the present disclosure, the fuel cell system 10 includes a first fuel cell stack 20, a second fuel cell stack 30 stacked on the first fuel cell stack 20, the first pipe member 110 connected to the first fuel cell stack 20 and configured to guide air discharged from the first fuel cell stack 20, the second pipe member 120 connected to the second fuel cell stack 30 and configured to communicate with the first pipe member 110, the second pipe member 120 being connected to the upper end of the first pipe member 110 based on the gravitational direction and configured to guide the air discharged from the second fuel cell stack 30, and the gas-liquid separation member 130 provided in the first pipe member 110 and the second pipe member 120 so that the droplets contained in the air, which moves upward along the first pipe member 110 and the second pipe member 120, may come into contact with the gas-liquid separation member 130.

The fuel cell system 10 may include a plurality of fuel cell stacks stacked in the gravitational direction (upward/downward direction). The present disclosure is not restricted or limited by the number of fuel cell stacks.

Hereinafter, an example is described in which the fuel cell system 10 includes the first fuel cell stack 20 and the second fuel cell stack 30 stacked in the gravitational direction. For example, the second fuel cell stack 30 may be stacked on an upper portion of the first fuel cell stack 20.

The first and second fuel cell stacks 20 and 30 each refer to a kind of power generation device that generates electrical energy through a chemical reaction of fuel (e.g., hydrogen), and each fuel cell stack may be configured by stacking several tens or hundreds of fuel cells (unit cells) in series.

The fuel cell may have various structures capable of producing electricity by means of an oxidation-reduction reaction between fuel (e.g., hydrogen) and an oxidant (e.g., air).

For example, the fuel cell may include: a membrane electrode assembly (MEA) (not illustrated) having catalyst electrode layers in which electrochemical reactions occur and which are attached to two opposite sides of an electrolyte membrane through which hydrogen ions move; a gas diffusion layer (GDL) (not illustrated) configured to uniformly distribute reactant gases and transfer generated electrical energy; a gasket (not illustrated) and a fastener (not illustrated) configured to maintain leakproof sealability for the reactant gases and a coolant and maintain an appropriate fastening pressure; and a separator (bipolar plate) (not illustrated) configured to move the reactant gases and the coolant.

More specifically, in the fuel cell, hydrogen, which is fuel, and air (oxygen), which is an oxidant, are supplied to an anode and a cathode of the membrane electrode assembly, respectively, through flow paths in the separator, such that the hydrogen is supplied to the anode, and the air is supplied to the cathode.

The hydrogen supplied to the anode is decomposed into hydrogen ions (protons) and electrons by catalysts in the electrode layers provided at two opposite sides of the electrolyte membrane. Only the hydrogen ions are selectively transmitted to the cathode through the electrolyte membrane, which is a cation exchange membrane, and at the same time, the electrons are transmitted to the cathode through the gas diffusion layer and the separator which are conductors.

At the cathode, the hydrogen ions supplied through the electrolyte membrane and the electrons transmitted through the separator meet oxygen in the air supplied to the cathode by an air supply device, thereby creating a reaction of producing water. As a result of the movement of the hydrogen ions, the electrons flow through external conductive wires, and the electric current is generated as a result of the flow of the electrons.

With reference to FIGS. 1-3, the first pipe member 110 is connected to the first fuel cell stack 20 and configured to guide the air, which is discharged from the first fuel cell stack 20, to the outside.

The first pipe member 110 may have various structures capable of guiding the air, which is discharged from the first fuel cell stack 20, to the outside. The present disclosure is not restricted or limited by the structure and shape of the first pipe member 110.

For example, a straight pipe or tube having a circular cross-section may be used as the first pipe member 110. The first pipe member 110 may be disposed such that an outlet thereof is directed upward (in an upward direction based on the gravitational direction).

According to another embodiment of the present disclosure, the first pipe member 110 may be formed in a curved shape or other shapes.

With reference to FIGS. 1-3, the second pipe member 120 communicates with the first pipe member 110 and is connected to the upper end of the first pipe member 110 based on the gravitational direction. The second pipe member 120 is configured to guide the air, which moves along the first pipe member 110 together with the air discharged from the second fuel cell stack 30, to the outside.

The second pipe member 120 may have various structures capable of guiding the air, which moves along the first pipe member 110 together with the air discharged from the second fuel cell stack 30, to the outside. The present disclosure is not restricted or limited by the structure and shape of the second pipe member 120.

For example, a straight pipe or tube having a circular cross-section may be used as the second pipe member 120. The second pipe member 120 may be disposed such that an outlet thereof is directed upward (in the upward direction based on the gravitational direction).

According to another embodiment of the present disclosure, the second pipe member 120 may be formed in a curved shape or other shapes.

With reference to FIGS. 1-3, the gas-liquid separation member 130 is configured to capture the droplets from the air that moves upward along the first pipe member 110 and the second pipe member 120.

More specifically, the gas-liquid separation member 130 is provided in the first pipe member 110 and the second pipe member 120 so that the droplets contained in the air, which moves upward along the first pipe member 110 and the second pipe member 120, may come into contact with the gas-liquid separation member 130. The droplets contained in the air, which moves upward along the first pipe member 110 and the second pipe member 120, may be captured while coming into contact with the gas-liquid separation member 130.

The gas-liquid separation member 130 may have various structures capable of capturing the droplets contained in the air. The present disclosure is not restricted or limited by the structure and shape of the gas-liquid separation member 130.

For example, a mesh member (e.g., a wire mesh) having a plurality of mesh holes may be used as the gas-liquid separation member 130. In particular, the gas-liquid separation member 130 may be provided to have an approximately cylindrical hollow shape.

According to another embodiment of the present disclosure, the gas-liquid separation member 130 may have a structure such as a porous structure, metal foam, fins, spiral structures, or iron scouring pads.

The gas-liquid separation member 130 may be made of various materials in accordance with required conditions and design specifications. The present disclosure is not restricted or limited by the material and properties of the gas-liquid separation member 130.

For example, the gas-liquid separation member 130 may be made of typical metal or synthetic resin (e.g., PVC).

According to an embodiment of the present disclosure, the gas-liquid separation member 130 is spaced apart from an inner surface of the first pipe member 110 and an inner surface of the second pipe member 120. A falling flow path 140 may be defined between the first pipe member 110, the second pipe member 120, and the gas-liquid separation member 130. The droplets, which are separated from the air by the gas-liquid separation member 130, may fall through the falling flow path 140.

As described above, in an embodiment of the present disclosure, the gas-liquid separation member 130 (e.g., the mesh member) is provided to be spaced apart from the inner surface of the first pipe member 110 and the inner surface of the second pipe member 120, and the falling flow path 140 is defined between the first pipe member 110, the second pipe member 120, and the gas-liquid separation member 130, such that the droplets D contained in the air may be captured by coming into contact with the gas-liquid separation member 130 while moving along the first pipe member 110 and the second pipe member 120. The air A, from which the droplets D are separated, may move upward (toward the outlet of the second pipe member 120) along an internal space of the gas-liquid separation member 130.

Further, the droplets D, which are captured by the inner surface of the first pipe member 110, the inner surface of the second pipe member 120, and the gas-liquid separation member 130, are agglomerated, such that the weights of the droplets D may increase. When the sizes (weights) of the droplets D increase, the gravitational force applied by the weight becomes higher than the drag force, such that the droplets D may more easily fall in a downward direction (a direction opposite to a direction toward the outlet) along the falling flow path 140.

In addition, when the air discharged from the first fuel cell stack 20 and the second fuel cell stack 30 is introduced into the first pipe member 110 and the second pipe member 120, a vortex of air having an approximately swirling shape is generated in the first pipe member 110 and the second pipe member 120.

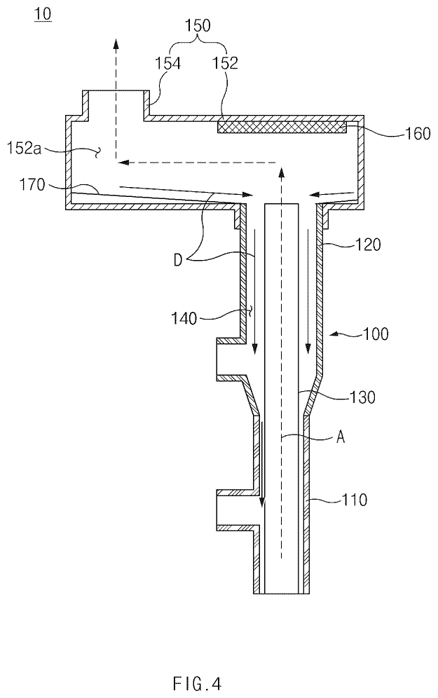

In this case, the droplets D contained in the air are pushed by a specific gravity difference and a centrifugal force applied by the vortex of air toward an edge (outer periphery) of the first pipe member 110 and an edge (outer periphery) of the second pipe member 120 based on a central portion of the first pipe member 110 and a central portion of the second pipe member 120 (the inside of the gas-liquid separation member 130). The droplets D may be captured by coming into contact with a surface of the gas-liquid separation member 130 while moving toward the edge of the first pipe member 110 and the edge of the second pipe member 120 via the gas-liquid separation member 130. Only the air A, from which the droplets D are removed, may move (upward) along an approximately central portion of the first pipe member 110 and an approximately central portion of the second pipe member 120 (the inside of the gas-liquid separation member 130) (see FIG. 4).

According to an embodiment of the present disclosure, the first pipe member 110 may be provided to have a first diameter D1 (or a first cross-sectional area), and the second pipe member 120 may be provided to have a second diameter D2 (or a second cross-sectional area) larger than the first diameter D1.

This is based on the fact that the droplets D are highly likely to be discharged (moved upward) in the second pipe member 120 because of an increase in flow velocity implemented as the air, which is discharged from the second fuel cell stack 30, and the air, which moves along the first pipe member 110 (the air discharged from the first fuel cell stack 20), merge with each other.

In an embodiment of the present disclosure, the second pipe member 120, which is provided at a downstream side of the first pipe member 110, has a larger diameter (cross-sectional area) than the first pipe member 110, such that a flow velocity (pressure drop) of the air passing through the second pipe member 120 may be reduced on the basis of Bernoulli's principle. Therefore, it is possible to advantageously further reduce the likelihood of the discharge of the droplets D (the upward movement of the droplets D) in the second pipe member 120.

According to an embodiment of the present disclosure, the fuel cell system 10 may include an exhaust duct 150 connected to an upper end of the second pipe member 120 and configured to discharge the air to the outside.

The exhaust duct 150 may be configured to additionally capture the droplets D contained in the air that moves along the second pipe member 120 (the air discharged from the first fuel cell stack 20 and the air discharged from the second fuel cell stack 30).

The exhaust duct 150 may have various structures capable of discharging the air, which moves along the second pipe member 120 (the air discharged from the first fuel cell stack 20 and the air discharged from the second fuel cell stack 30), to the outside. The present disclosure is not restricted or limited by the structure of the exhaust duct 150.

According to an embodiment of the present disclosure, the exhaust duct 150 may include a duct housing 152 connected to the upper end of the second pipe member 120 and having a larger volume than the second pipe member 120, and a discharge port 154 provided in the duct housing 152 and configured to discharge the air to the outside of the duct housing 152.

The duct housing 152 may have various structures having a larger volume (or cross-sectional area) than the second pipe member 120. The present disclosure is not restricted or limited by the structure and shape of the duct housing 152.

For example, the duct housing 152 may have an approximately quadrangular box shape. Alternatively, the duct housing 152 may have a cylindrical shape or other shapes.

According to an embodiment of the present disclosure described above, the duct housing 152 has a larger volume than the second pipe member 120, such that the flow velocity of the air discharged through the second pipe member 120 may be reduced on the basis of Bernoulli's principle. Therefore, it is possible to advantageously and more effectively capture the droplets D contained in the air on an inner surface of the duct housing 152.

The discharge port 154 is provided in the duct housing 152 in order to finally discharge the air having passed through the duct housing 152.

The discharge port 154 may be variously changed in position in accordance with required conditions and design specifications. The present disclosure is not restricted or limited by the position of the discharge port 154.

According to an embodiment of the present disclosure, the second pipe member 120 may be connected to one end (a right end based on FIG. 1) of the duct housing 152, and the discharge port 154 is provided at the other end (a left end based on FIG. 1) of the duct housing 152 and spaced apart from the outlet of the second pipe member 120. A horizontal movement flow path 152a may be defined between the outlet of the second pipe member 120 and the discharge port 154, and the air may move in a horizontal direction through the horizontal movement flow path 152a.

According to an embodiment of the present disclosure described above, the second pipe member 120 is connected to one end of the duct housing 152, and the discharge port 154 is provided at the other end of the duct housing 152, such that a movement route for the air passing through the duct housing 152 may be further extended (a contact area with the droplets D may be increased). Therefore, it is possible to advantageously improve the efficiency in capturing the droplets by means of the duct housing 152.

In particular, the discharge port 154 is provided at the other end of the duct housing 152 and spaced apart from the outlet of the second pipe member 120. The discharge port 154 may be configured to discharge the air to the outside in the gravitational direction. For example, the discharge port 154 may be provided in an upper surface at the other end of the duct housing 152. Alternatively, the discharge port 154 may be provided in a lateral surface or a bottom surface of the duct housing 152.

According to an embodiment of the present disclosure described above, the discharge port 154 discharges the air in the gravitational direction, such that the air, which moves along the horizontal movement flow path 152a in the duct housing 152, may collide (come into contact) with the inner surface of the duct housing 152 once more and then be discharged through the discharge port 154. Therefore, it is possible to advantageously further improve the efficiency in capturing the droplets by means of the duct housing 152.

The air discharged through the discharge port 154 may be discharged directly to the outside or supplied again to the first fuel cell stack 20 or the second fuel cell stack 30 along an air supply line (not illustrated) through which the air is supplied to the first fuel cell stack 20 or the second fuel cell stack 30.

According to an embodiment of the present disclosure, the fuel cell system 10 may include a droplet capturing member 160 provided on the inner surface of the duct housing 152 and configured to capture the droplets D contained in the air discharged from the second pipe member 120.

The droplet capturing member 160 may have various structures capable of capturing the droplets D contained in the air. The present disclosure is not restricted or limited by the structure and shape of the droplet capturing member 160.

For example, a mesh member (e.g., a wire mesh) having a plurality of mesh holes may be used as the droplet capturing member 160. For example, the droplet capturing member 160 may have a plate shape having a larger cross-sectional area than the outlet of the second pipe member 120.

According to another embodiment of the present disclosure, the droplet capturing member 160 may have a structure such as a porous structure, metal foam, fins, spiral structures, or iron scouring pads.

According to an embodiment of the present disclosure described above, the droplet capturing member 160 is provided on the inner surface of the duct housing 152, such that the contact area with the droplets D may further increase. Therefore, it is possible to advantageously further improve the efficiency in capturing the droplets D.

The droplet capturing member 160 may be provided at various positions in accordance with required conditions and design specifications. The present disclosure is not restricted or limited by the position of the droplet capturing member 160.

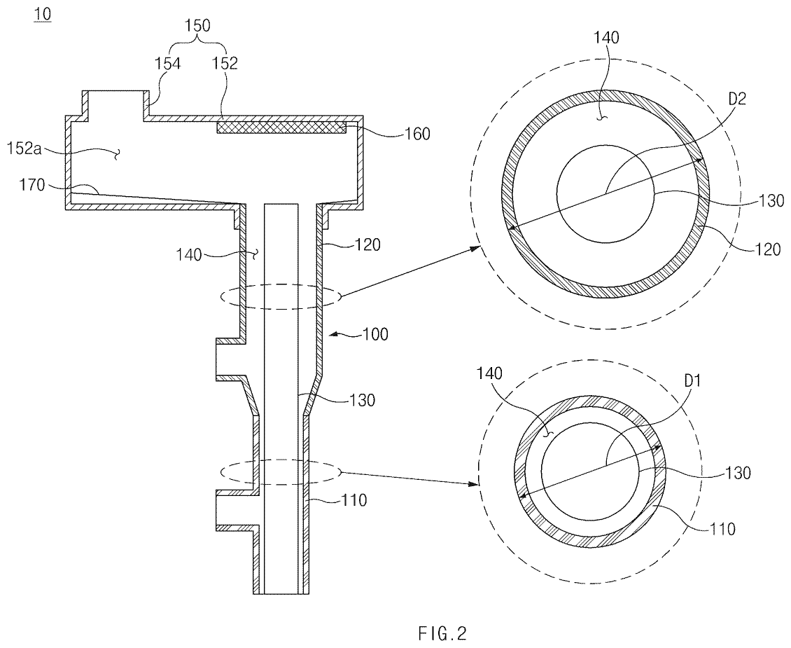

According to an embodiment of the present disclosure, the droplet capturing member 160 may be provided on the inner surface of the duct housing 152 (an inner surface of an upper portion of the duct housing 152 based on FIG. 2) that faces the outlet of the second pipe member 120.

According to an embodiment of the present disclosure described above, the droplet capturing member 160 is provided on the inner surface of the duct housing 152 that faces the outlet of the second pipe member 120, such that the air discharged from the outlet of the second pipe member 120 may collide (come into contact) directly with the droplet capturing member 160 and then move along the horizontal movement flow path 152a. Therefore, it is possible to advantageously further improve the efficiency in capturing the droplets D by means of the droplet capturing member 160.

According to an embodiment of the present disclosure, the fuel cell system 10 may include an inclined guide part 170 provided on a bottom portion of the duct housing 152 and configured to guide the droplets D, which are captured in the duct housing 152, to the second pipe member 120.

According to an embodiment of the present disclosure described above, the inclined guide part 170 is provided on the bottom portion of the duct housing 152, such that the droplets D captured in the duct housing 152 may naturally flow downward along the inclined guide part 170 and then be introduced into the second pipe member 120 without stagnating in the duct housing 152.

Moreover, the droplets D, which are introduced into the second pipe member 120 along the inclined guide part 170, may be agglomerated with other droplets D in the second pipe member 120 (or the first pipe member 110) and form droplets D having large sizes. Therefore, it is possible to advantageously further improve the efficiency in capturing and discharging the droplets D.

According to an embodiment of the present disclosure, the fuel cell system 10 may include a water trap 180 connected to a lower end of the first pipe member 110.

The water trap 180 may have various structures capable of storing the droplets D, which flow downward along the second pipe member 120 and the first pipe member 110, and selectively discharging the droplets D. The present disclosure is not restricted or limited by the type and structure of the water trap 180. In particular, the water trap 180 may be configured to selectively discharge the droplets D (condensate water), which are stored in the water trap 180, at a predetermined particular location.

In the embodiment of the present disclosure illustrated and described above, the example has been described in which the droplets D captured in the duct housing 152 flow downward along the inclined guide part 170 and then are introduced into the water trap 180 via the second pipe member 120. However, according to another embodiment of the present disclosure, a separate discharge line (not illustrated) may be provided to connect the duct housing 152 and the water trap 180, and the droplets D captured in the duct housing 152 may be introduced into the water trap 180 along the discharge line.

According to an embodiment of the present disclosure, the fuel cell system 10 may include a casing 40 provided to surround a periphery of the first fuel cell stack 20 and a periphery of the second fuel cell stack 30.

The casing 40 may have various structures capable of surrounding the periphery of the first fuel cell stack 20 and the periphery of the second fuel cell stack 30. The present disclosure is not restricted or limited by the structure and shape of the casing 40.

In particular, the first pipe member 110, the second pipe member 120, and the exhaust duct 150, which constitute the gas-liquid separator 100, may be provided in the casing 40.

More particularly, the exhaust duct 150 may be disposed in a dead zone present at an uppermost end of the casing 40.

According to an embodiment of the present disclosure described above, the exhaust duct 150 is provided in the dead zone in the casing 40, such that a sufficient available space in the casing 40 may be ensured, and the casing 40 and the fuel cell system 10 may be more compactly configured.

According to an embodiment of the present disclosure described above, it is possible to advantageously and effectively capture the droplets contained in the air discharged from the fuel cell stack.

In particular, according to an embodiment of the present disclosure, it is possible to advantageously simplify the discharge route for the air while ensuring the performance in capturing the droplets contained in the air discharged from the fuel cell stack.

Among other things, according to an embodiment of the present disclosure, it is possible to effectively capture the droplets contained in the air discharged from the fuel cell stack without using the water trap. Therefore, it is possible to advantageously simplify the structure, contribute to miniaturizing the fuel cell system, and improve the degree of design freedom and spatial utilization.

While embodiments have been described above, the embodiments are just illustrative and not intended to limit the present disclosure. It can be appreciated by those having ordinary skill in the art that various modifications and applications, which are not described above, may be made to the present embodiment without departing from the intrinsic features of the present embodiment. For example, the respective constituent elements specifically described in the embodiments may be modified and then carried out. Further, it should be interpreted that the differences related to the modifications and applications are included in the scope of the present disclosure defined by the appended claims.

What is claimed is:

1. A gas-liquid separator comprising:
a first pipe member;
a second pipe member configured to communicate with the first pipe member and connected to an upper end of the first pipe member based on a gravitational direction; and
a gas-liquid separation member provided in the first pipe member and the second pipe member so that droplets contained in air, which moves upward along the first pipe member and the second pipe member, come into contact with the gas-liquid separation member.

2. The gas-liquid separator of claim 1, wherein the gas-liquid separation member is spaced apart from an inner surface of the first pipe member and an inner surface of the second pipe member,
wherein a falling flow path is defined between the first pipe member, the second pipe member, and the gas-liquid separation member, and
wherein the droplets, which are separated from the air by the gas-liquid separation member, fall through the falling flow path.

3. The gas-liquid separator of claim 1, wherein the first pipe member has a first diameter, and the second pipe member has a second diameter larger than the first diameter.

4. The gas-liquid separator of claim 1, wherein the gas-liquid separation member comprises a mesh member having mesh holes.

5. The gas-liquid separator of claim 1, further comprising:
an exhaust duct connected to an upper end of the second pipe member and configured to discharge the air to the outside.

6. The gas-liquid separator of claim 5, wherein the exhaust duct comprises:
a duct housing connected to the upper end of the second pipe member and having a larger volume than the second pipe member; and
a discharge port provided in the duct housing and configured to discharge the air to the outside.

7. The gas-liquid separator of claim 6, wherein the second pipe member is connected to one end of the duct housing, the discharge port is provided at the other end of the duct housing and spaced apart from an outlet of the second pipe member, and a horizontal movement flow path, through which the air moves in a horizontal direction, is defined between the outlet of the second pipe member and the discharge port.

8. The gas-liquid separator of claim 7, wherein the discharge port is configured to discharge the air to the outside in the gravitational direction.

9. The gas-liquid separator of claim 6, further comprising:
a droplet capturing member provided on an inner surface of the duct housing and configured to capture droplets contained in the air discharged from the second pipe member.

10. The gas-liquid separator of claim 6, further comprising:
an inclined guide part provided on a bottom portion of the duct housing and configured to guide droplets, which are captured in the duct housing, to the second pipe member.

11. A fuel cell system comprising:
a first fuel cell stack;
a second fuel cell stack stacked on the first fuel cell stack;
a first pipe member connected to the first fuel cell stack and configured to guide air discharged from the first fuel cell stack;
a second pipe member connected to the second fuel cell stack and configured to communicate with the first pipe member, the second pipe member being connected to an upper end of the first pipe member based on a gravitational direction and configured to guide air discharged from the second fuel cell stack; and
a gas-liquid separation member provided in the first pipe member and the second pipe member so that droplets contained in air, which moves upward along the first pipe member and the second pipe member, come into contact with the gas-liquid separation member.

12. The fuel cell system of claim 11, wherein the gas-liquid separation member is spaced apart from an inner surface of the first pipe member and an inner surface of the second pipe member,
wherein a falling flow path is defined between the first pipe member, the second pipe member, and the gas-liquid separation member, and
wherein the droplets, which are separated from the air by the gas-liquid separation member, fall along the falling flow path.

13. The fuel cell system of claim 11, wherein the first pipe member has a first diameter, and the second pipe member has a second diameter larger than the first diameter.

14. The fuel cell system of claim 11, further comprising:
an exhaust duct connected to an upper end of the second pipe member and configured to discharge the air to the outside.

15. The fuel cell system of claim 14, wherein the exhaust duct comprises:
a duct housing connected to the upper end of the second pipe member and having a larger volume than the second pipe member; and
a discharge port provided in the duct housing and configured to discharge the air to the outside.

16. The fuel cell system of claim 15, wherein the second pipe member is connected to one end of the duct housing, the discharge port is provided at the other end of the duct housing and spaced apart from an outlet of the second pipe member, and a horizontal movement flow path, through which the air moves in a horizontal direction, is defined between the outlet of the second pipe member and the discharge port.

17. The fuel cell system of claim 15, further comprising:
a droplet capturing member provided on an inner surface of the duct housing and configured to capture droplets contained in the air discharged from the second pipe member.

18. The fuel cell system of claim 15, further comprising:
an inclined guide part provided on a bottom portion of the duct housing and configured to guide droplets, which are captured in the duct housing, to the second pipe member.

19. The fuel cell system of claim 14, further comprising:
a casing provided to surround a periphery of the first fuel cell stack and a periphery of the second fuel cell stack.

20. The fuel cell system of claim 19, wherein the first pipe member, the second pipe member, and the exhaust duct are provided in the casing.
